(19) United States
(12) Patent Application Publication
(10) Pub. No.: US 2023/0075161 A1
(43) Pub. Date: Mar. 9, 2023

(54) POWER TRANSMISSION APPARATUS, POWER RECEPTION APPARATUS, CONTROL METHOD, AND COMPUTER-READABLE STORAGE MEDIUM

(71) Applicant: CANON KABUSHIKI KAISHA, Tokyo (JP)

(72) Inventor: Hajime Shimura, Kanagawa (JP)

(21) Appl. No.: 18/049,998

(22) Filed: Oct. 26, 2022

Related U.S. Application Data
(63) Continuation of application No. PCT/JP2021/014640, filed on Apr. 6, 2021.

(30) Foreign Application Priority Data
Apr. 30, 2020 (JP) 2020-080693

(51) Int. Cl. H02J 50/60; H02J 50/12

(52) U.S. Cl. CPC H02J 50/60; H02J 50/12

(57) ABSTRACT

A power transmission apparatus that wirelessly transmits power to a power reception apparatus via an antenna controls to limit power transmission in the power transmission during a predetermined period, and detects an object different from the power reception apparatus based on a temporal change of a voltage or a current of the antenna corresponding to a first frequency during the predetermined period when the power transmission is limited and a temporal change of a voltage or a current of the antenna corresponding to a second frequency different from the first frequency, during the period when the power transmission is limited.

### CROSS-REFERENCE TO RELATED APPLICATIONS

This application is a Continuation of International Patent Application No. PCT/JP2021/014640, filed Apr. 6, 2021, which claims the benefit of Japanese Patent Application No. 2020-080693 filed Apr. 30, 2020, both of which are hereby incorporated by reference herein in their entirety.

### BACKGROUND

### Field of the Disclosure

The present disclosure relates to an object detection technique in wireless power transfer.

### Background Art

Technology development of wireless power transfer systems has widely been conducted, and a standard (WPC standard) formulated as a wireless power charging standard by a standardization organization, the Wireless Power Consortium (WPC), is widely known. In such wireless power transfer, it is important that if a foreign object exists in a range where a power transmission apparatus can transfer power, the foreign object is detected, and power transmission/reception is controlled. The foreign object is an object different from a power reception apparatus. Japanese Patent Laid-Open No. 2017-070074 describes a method of, if a foreign object exists near a power transmission/reception apparatus complying with the WPC standard, detecting the foreign object and limiting power transmission/reception. Japanese Patent Laid-Open No. 2015-027172 describe a method in which a power transmission apparatus transmits a signal for foreign object detection to a power reception apparatus, and determines the presence/absence of a foreign object using an echo signal from the power reception apparatus. Japanese Patent Laid-Open No. 2017-034972 describes a technique of performing foreign object detection by short-circuiting a coil of a wireless power transfer system.

### SUMMARY

The present disclosure provides a technique of accurately performing detection of an object different from a power reception apparatus.

According to an aspect of the present disclosure, there is provided a power transmission apparatus comprising a power transmission unit configured to wirelessly transmit power to a power reception apparatus via an antenna, a control unit configured to control to limit power transmission by the power transmission unit during a period, and a detection unit configured to detect an object different from the power reception apparatus based on a temporal change of a voltage or a current of the antenna corresponding to a first frequency, which is a temporal change of a voltage or a current of the antenna during the period when the power transmission is limited and based on a temporal change of a voltage or a current of the antenna corresponding to a second frequency different from the first frequency, during the period when the power transmission is limited.

According to another aspect of the present disclosure, there is provided a power reception apparatus comprising: a power reception unit configured to wirelessly receive power from a power transmission apparatus via an antenna; and a detection unit configured to detect an object different from the power transmission apparatus based on a temporal change of a voltage or a current corresponding to a first frequency, which is a temporal change of a voltage or a current of the antenna during a predetermined period in which power transmission from the power transmission apparatus is limited, and a temporal change of a voltage or a current corresponding to a second frequency different from the first frequency.

Further features of the present disclosure will become apparent from the following description of exemplary embodiments with reference to the attached drawings.

### BRIEF DESCRIPTION OF THE DRAWINGS

FIG. 1 is a view showing an example of the configuration of a wireless power transfer system.

FIG. 2 is a block diagram showing an example of the configuration of a power transmission apparatus.

FIG. 3 is a block diagram showing an example of the configuration of a power reception apparatus.

FIG. 4 is a block diagram showing an example of the functional configuration of the control unit of the power transmission apparatus.

FIG. 5 is a sequence chart showing an example of the procedure of processing of power transfer complying with the WPC standard.

FIG. 6 is a view for explaining the principle of foreign object detection by a waveform attenuation method.

FIG. 7 is a view for explaining a method of performing foreign object detection using a transmitted power waveform during power transmission.

FIG. 8 is a view for explaining a method of performing foreign object detection.

FIG. 9 is a view for explaining a method of performing foreign object detection.

FIG. 10 is a view for explaining a setting method of a foreign object detection threshold by the Power Loss method.

FIG. 11 is a flowchart showing an example of the procedure of processing executed by the power transmission apparatus.

FIG. 12 is a flowchart showing an example of the procedure of processing executed by the power reception apparatus.

### DESCRIPTION OF THE EMBODIMENTS

Hereinafter, embodiments will be described in detail with reference to the attached drawings. Note, the following embodiments are not intended to limit the scope of the disclosure. Multiple features are described in the embodiments, but limitation is not made to a disclosure that requires all such features, and multiple such features may be combined as appropriate. Furthermore, in the attached drawings, the same reference numerals are given to the same or similar configurations, and redundant description thereof is omitted.

(Configuration of Wireless Power Transfer System)

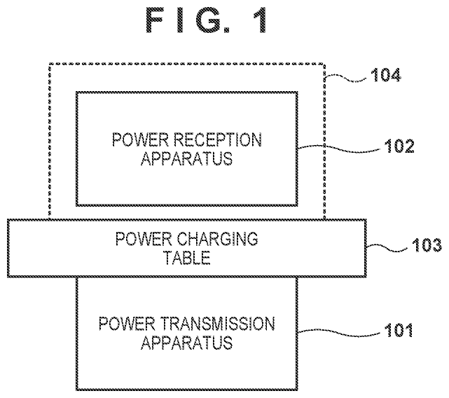

FIG. 1 shows an example of the configuration of a wireless power transfer system according to this embodiment. This system is, for example, a wireless power charging system. This system is configured to include a power transmission apparatus 101 and a power reception apparatus 102. The power transmission apparatus 101 will also be referred to as a TX, and the power reception apparatus 102 as an RX hereinafter. The RX is an electronic device that includes an internal battery, and charges the internal battery with power received from the TX. The TX is an electronic device that wirelessly transmits power to the RX placed on, for example, a power charging table 103 prepared as a part of the housing of the TX. Note that since the power charging table 103 is a part of the TX, “placed on the power charging table 103” will sometimes be expressed as “placed on the TX (power transmission apparatus 101)” hereinafter. A range 104 indicated by a broken line is a range in which the RX can receive power from the TX. Note that the TX and the RX can have a function of executing an application other than wireless power charging. The RX is, for example, a smartphone, and the TX is, for example, an accessory device configured to charge the smartphone. Note that the TX and the RX may each be a tablet or a storage device such as a hard disk drive or a memory device, or may be an information processing apparatus such as a personal computer (PC). Alternatively, the TX and the RX may each be, for example, an image input device such as an image capturing device (a camera or a video camera) or a scanner, or an image output device such as a printer, a copying machine, or a projector. Also, the RX may be, for example, a vehicle such as an automobile, and the TX may be a power charger installed on the console or the like of an automobile.

This system performs wireless power transfer using an electromagnetic induction method for wireless power charging based on the WPC standard. That is, the TX and the RX perform wireless power transfer for wireless power charging based on the WPC standard between the power transmission antenna of the TX and the power reception antenna of the RX. Note that in this system a method defined by the WPC standard is used as the wireless power transfer method. However, the present disclosure is not limited to this, and another method may be used. For example, an electromagnetic induction method, a magnetic field resonance method, an electric field resonance method, a microwave method, or a method using a laser or the like, may be used. Also, in this embodiment, wireless power transfer is used for wireless power charging. However, wireless power transfer may be performed for an application purpose other than wireless power charging.

In the WPC standard, the magnitude of power guaranteed when the power reception apparatus 102 receives power from the power transmission apparatus 101 is defined by a value called Guaranteed Power (to be referred to as “GP” hereinafter). The GP indicates a power value that guarantees output to a load (for example, a circuit for power charging, a battery, or the like) of the power reception apparatus 102 even if, for example, the positional relationship between the power reception apparatus 102 and the power transmission apparatus 101 varies, and the power transmission efficiency between the power reception antenna and the power transmission antenna lowers. For example, in a case where the GP is 5 W, even if the positional relationship between the power reception antenna and the power transmission antenna varies, and the power transmission efficiency lowers, the power transmission apparatus 101 performs power transmission by executing control to output 5 W to the load in the power reception apparatus 102.

Also, at the time of power transmission from the power transmission apparatus 101 to the power reception apparatus 102, if a foreign object that is not the power reception apparatus exists near the power transmission apparatus 101, the electromagnetic wave for power transmission may affect the foreign object and raise the temperature of the foreign object, and in some cases, break the foreign object. In the WPC standard, to take a measure of, for example, stopping power transmission if a foreign object exists, a method of the power transmission apparatus 101 to detect the existence of a foreign object on, for example, the power charging table 103 is defined. More specifically, a Power Loss method of detecting a foreign object based on the relationship between transmitted power in the power transmission apparatus 101 and received power in the power reception apparatus 102 is defined. In addition, a Q-Factor measuring method of detecting a foreign object based on the change of the quality coefficient (Q-Factor) of the power transmission antenna (power transmission coil) in the power transmission apparatus 101 is defined. Note that the power transmission apparatus 101 can not only detect an object existing on the power charging table 103 as a foreign object but also detect a foreign object located near the power transmission apparatus 101. For example, the power transmission apparatus 101 may detect a foreign object existing in the power transmission enable range 104.

Foreign object detection based on the Power Loss method defined by the WPC standard will be described with reference to FIG. 10. The abscissa of FIG. 10 represents the transmitted power of the power transmission apparatus 101, and the ordinate represents the received power of the power reception apparatus 102. Note that a foreign object is an object other than the power reception apparatus 102, which may affect power transmission from the power transmission apparatus 101 to the power reception apparatus 102, and is, for example, an object with conductivity, such as a metal piece.

First, the power transmission apparatus 101 transmits power of a first transmitted power value Pt1 to the power reception apparatus 102, and the power reception apparatus 102 obtains received power of a first received power value Pr1. Note that this state can be called a Light Load state. The power transmission apparatus 101 stores the first transmitted power value Pt1. Here, the first transmitted power value Pt1 or the first received power value Pr1 is minimum transmitted power or received power determined in advance. At this time, the power reception apparatus 102 controls loads such that the received power becomes the minimum power. For example, the power reception apparatus 102 may disconnect the loads from the power reception antenna such that the received power is not supplied to the loads (a power charging circuit and a battery, and the like). The power reception apparatus 102 reports the first received power value Pr1 to the power transmission apparatus 101. Upon receiving the first received power value Pr1 from the power reception apparatus 102, the power transmission apparatus 101 calculates the power loss between the power transmission apparatus 101 and the power reception apparatus 102 as Pt1−Pr1 (Ploss1) and creates a calibration point 1000 representing the correspondence between Pt1 and Pr1.

Next, the power transmission apparatus 101 changes the transmitted power value to a second transmitted power value Pt2 and transmits power to the power reception apparatus 102, and the power reception apparatus 102 obtains received power of a second received power value Pr2. Note that this state can be called a Connected Load state. The power transmission apparatus 101 stores the second transmitted power value Pt2. Here, the second transmitted power value Pt2 or the second received power value Pr2 is maximum transmitted power or received power determined in advance. At this time, the power reception apparatus 102 controls the loads such that the received power becomes the maximum power. For example, the power reception apparatus 102 connects the power reception antenna and the loads such that the received power is supplied to the loads. The power reception apparatus 102 reports the second received power value Pr2 to the power transmission apparatus 101. Upon receiving the second received power value Pr2 from the power reception apparatus 102, the power transmission apparatus 101 calculates the power loss between the power transmission apparatus 101 and the power reception apparatus 102 as Pt2−Pr2 (Ploss2) and creates a calibration point 1001 representing the correspondence between Pt2 and Pr2.

Then, the power transmission apparatus 101 creates a line 1002 that linearly interpolates between the calibration point 1000 and the calibration point 1001. The line 1002 represents the relationship between the transmitted power and the received power in a state in which no foreign object exists near the power transmission apparatus 101 and the power reception apparatus 102. The power transmission apparatus 101 can predict, based on the line 1002, a power value that the power reception apparatus 102 receives in a case where predetermined power is transmitted in a state in which no foreign object exists. For example, if the power transmission apparatus 101 transmits power of a third transmitted power value Pt3, a third received power value Pr3 to be received by the power reception apparatus 102 can be estimated based on a point 1003 on the line 1002, which corresponds to Pt3.

As described above, based on a plurality of combinations of the transmitted power values of the power transmission apparatus 101 and the received power values of the power reception apparatus 102, which are measured while changing the load, the power loss between the power transmission apparatus 101 and the power reception apparatus 102 according to the load can be specified. It is also possible to estimate the power loss between the power transmission apparatus 101 and the power reception apparatus 102 according to the load by interpolation based on the plurality of combinations. Calibration processing thus performed by the power transmission apparatus 101 and the power reception apparatus 102 to cause the power transmission apparatus 101 to obtain the combination of the transmitted power value and the received power value will be referred to as “Calibration processing (CAL processing) of the Power Loss method” below.

Assume that if the power transmission apparatus 101 actually transmits power of Pt3 to the power reception apparatus 102 after calibration, the power transmission apparatus 101 receives a received power value Pr3′ from the power reception apparatus 102. The power transmission apparatus 101 calculates Pr3−Pr3′(=Ploss_FO) that is a value obtained by subtracting the received power value Pr3′ actually received from the power reception apparatus 102 from the received power value Pr3 in a state in which a foreign object does not exist. Ploss_FO can be considered as a power loss by power consumed by a foreign object if the foreign object exists near the power transmission apparatus 101 and the power reception apparatus 102. Hence, if the power Ploss_FO that would be consumed by the foreign object exceeds a predetermined threshold, the power transmission apparatus 101 can determine that a foreign object exists. Alternatively, the power transmission apparatus 101 calculates a power loss Pt3−Pr3 (Ploss3) between the power transmission apparatus 101 and the power reception apparatus 102 from the received power value Pr3 in a state in which a foreign object does not exist. Next, the power transmission apparatus 101 calculates a power loss Pt3−Pr3′ (Ploss3′) between the power transmission apparatus 101 and the power reception apparatus 102 using the received power value Pr3′ received from the power reception apparatus 102. Then, using Ploss3′−Ploss3 (=Ploss_FO), the power transmission apparatus 101 may estimate the power Ploss_FO that would be consumed by the foreign object.

As described above, the power Ploss_FO that would be consumed by the foreign object may be calculated as Pr3−Pr3′ based on the received power, or may be calculated as Ploss3′−Ploss3 based on the magnitude of the power loss. Note that Ploss_FO is assumed to be calculated by Ploss3′−Ploss3 below. However, Ploss_FO may be calculated by Pr3−Pr3′.

Foreign object detection by the Power Loss method is executed during power transfer (during a Power Transfer phase to be described later) based on data obtained by a Calibration phase to be described later. Also, foreign object detection by the Q-Factor measuring method is executed before power transfer (before transmission of a Digital Ping to be described later and during a Negotiation Phase or a Renegotiation phase).

The RX and the TX according to this embodiment perform communication for power transmission/reception control based on the WPC standard. The WPC standard defines a plurality of phases including a Power Transfer phase in which power transfer is executed and one or more phases before actual power transfer, and communication necessary for power transmission/reception control is performed in each phase. The phases before power transfer can include a Selection phase, a Ping phase, an Identification and Configuration phase, a Negotiation phase, and a Calibration phase. Note that the Identification and Configuration phase will be referred to as an I&C phase hereinafter. Processing of each phase will be described below.

In the Selection phase, the TX intermittently transmits an Analog Ping, and detects that an object is placed on the power charging table of the TX (for example, that the RX or a conductor piece is placed on the power charging table). The TX detects at least one of the voltage value and the current value of the power transmission antenna at the time of Analog Ping transmission, judges that an object exists if the voltage value is less than a certain threshold or the current value exceeds a certain threshold, and transits to the Ping phase.

In the Ping phase, the TX transmits a Digital Ping whose power is larger than the Analog Ping. As for the magnitude of the power of the Digital Ping, the power is large enough to activate the control unit of the RX placed on the TX. The RX notifies the TX of the magnitude of the received voltage. In this way, the TX receives the response from the RX that has received the Digital Ping transmitted by the self-apparatus, thereby recognizing that the object detected in the Selection phase is the RX. Upon receiving the notification of the received voltage value, the TX transits to the I&C phase. Also, before the Digital Ping is transmitted, the TX measures the Q-Factor of the power transmission antenna. The measurement result is used when executing foreign object detection processing using a Q-Factor measuring method.

In the I&C phase, the TX identifies the RX, and obtains device configuration information (capability information) from the RX. The RX transmits an ID Packet and a Configuration Packet. The ID Packet includes identifier information of the RX, and the Configuration Packet includes the device configuration information (capability information) of the RX. Upon receiving the ID Packet and the Configuration Packet, the TX responds by an acknowledge (ACK, acknowledgement). Then, the I&C phase ends.

In the Negotiation phase, the value of GP is decided based on the value of GP requested by the RX, the power transmission capability of the TX, and the like. In addition, the TX executes foreign object detection processing using the Q-Factor measuring method in accordance with, for example, a request from the RX. Also, the WPC standard defines that after shifting to the Power Transfer phase once, the same processing as in the Negotiation phase is performed again in accordance with a request from the RX. The phase for performing the processing again after shifting to the Power Transfer phase is called a Renegotiation phase.

In the Calibration phase, Calibration is executed based on the WPC standard. In addition, the RX notifies the TX of a predetermined received power value (the received power value in the light load state/the received power value in the maximum load state), and adjustment is performed to allow the TX to efficiently transmit power. The received power value notified to the TX can be used for foreign object detection processing by the Power Loss method.

In the Power Transfer phase, control is performed to start or continue power transmission or stop power transmission due to an error or full charge. For the power transmission/reception control, using the power transmission antenna and the power reception antenna, which are used to do wireless power transfer based on the WPC standard, the TX and the RX perform communication by superimposing a signal on an electromagnetic wave transmitted from the power transmission antenna or the power reception antenna. Note that the range in which communication based on the WPC standard can be performed between the TX and the RX is almost the same as the power transmission enable range of the TX.

(Configurations of Power Transmission Apparatus 101 and Power Reception Apparatus 102)

An example of the configurations of the power transmission apparatus 101 (TX) and the power reception apparatus 102 (RX) according to this embodiment will be described next. Note that each configuration to be described below is merely an example, and a part (or the whole in some cases) of the configuration to be described may be replaced with another configuration having another similar function or may be omitted, or a further configuration may be added. Furthermore, one block shown in the following description may be divided into a plurality of blocks, and a plurality of blocks may be integrated into one block. Each functional block to be described below can be implemented by one or more processors executing a software instruction. However, some or all functions included in each functional block may be implemented by hardware.

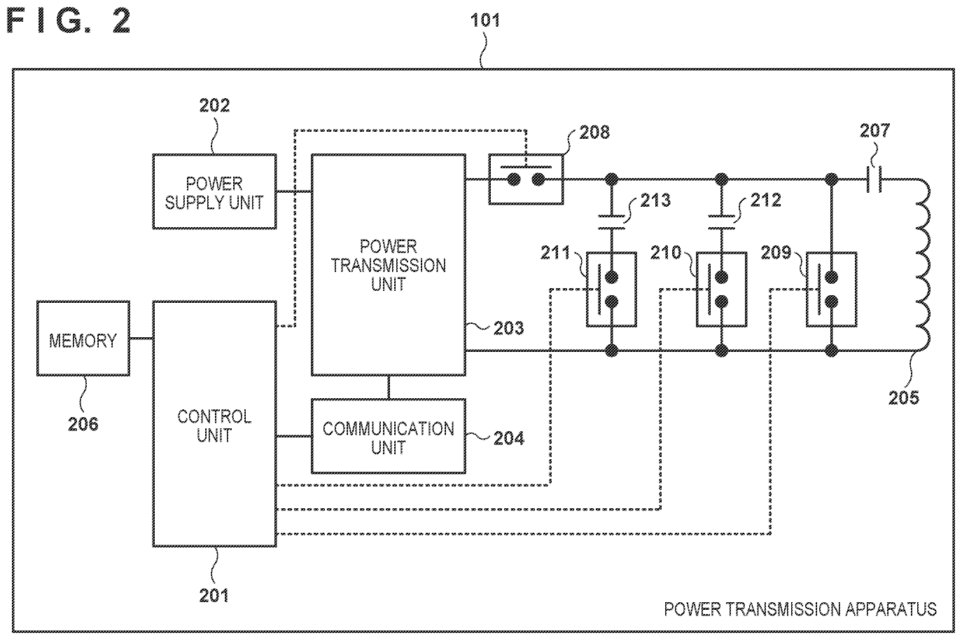

FIG. 2 shows an example of the configuration of the power transmission apparatus 101 (TX) according to this embodiment. The TX is configured to include, for example, a control unit 201, a power supply unit 202, a power transmission unit 203, a communication unit 204, a power transmission antenna 205, a memory 206, resonant capacitors 207, 212, and 213, and switches 208 to 211. Note that FIG. 2 shows the control unit 201, the power supply unit 202, the power transmission unit 203, the communication unit 204, and the memory 206 as separate functional blocks. Two or more or all of these functional blocks may be implemented in the same chip.

The control unit 201 executes a control program stored in, for example, the memory 206, thereby executing control of the entire TX. That is, the control unit 201 executes control of each functional unit shown in FIG. 2. Also, the control unit 201 executes control concerning power transmission control including communication for device authentication in the TX. Furthermore, the control unit 201 may perform control to execute an application other than wireless power transfer. The control unit 201 is configured to include, for example, at least one processor such as a CPU (Central Processing Unit) or an MPU (Micro Processor Unit). Note that the control unit 201 may be formed by hardware such as an ASIC (Application Specific Integrated Circuit). The control unit 201 may also be configured to include an array circuit such as an FPGA (Field Programmable Gate Array) compiled to execute predetermined processing. The control unit 201 stores, in the memory 206, information that should be stored during execution of various kinds of processing. Also, the control unit 201 can measure a time using a timer (not shown).

The power supply unit 202 supplies power to each functional block. The power supply unit 202 is, for example, a commercial power supply or a battery. The battery stores power supplied from the commercial power supply.

The power transmission unit 203 converts direct current or alternating current power input from the power supply unit 202 into power of an alternating current frequency in a frequency band used for wireless power transfer, and inputs the power to the power transmission antenna 205, thereby generating an electromagnetic wave to be received by the RX. For example, the power transmission unit 203 converts a direct voltage supplied from the power supply unit 202 into an alternating voltage by a switching circuit having a half bridge or full bridge configuration using an FET (Field Effect Transistor). In this case, the power transmission unit 203 includes a gate driver that ON/OFF-controls the FET. The power transmission unit 203 also adjusts one or both of the voltage (transmission voltage) and the current (transmission current) input to the power transmission antenna 205, thereby controlling the intensity of the electromagnetic wave to be output. If the transmission voltage or the transmission current is made large, the intensity of the electromagnetic wave increases. If the transmission voltage or the transmission current is made small, the intensity of the electromagnetic wave decreases. In addition, based on an instruction from the control unit 201, the power transmission unit 203 performs output control of the power to start or stop power transmission from the power transmission antenna 205. Also, the power transmission unit 203 has a capability of supplying power to output power of 15 watt (W) to the power charging unit of the power reception apparatus 102 (RX) supporting the WPC standard.

The communication unit 204 performs communication with the RX for power transmission control based on the WPC standard as described above. The communication unit 204 modulates the electromagnetic wave output from the power transmission antenna 205 and transfers information to the RX, thereby performing communication. In addition, the communication unit 204 demodulates the electromagnetic wave transmitted from the power transmission antenna 205 and modulated by the RX, thereby obtaining information transmitted from the RX. That is, the communication performed by the communication unit 204 is performed by superimposing a signal on the electromagnetic wave transmitted from the power transmission antenna 205. Also, the communication unit 204 may communicate with the RX by communication using an antenna different from the power transmission antenna 205 and based on a standard different from the WPC standard, or may communicate with the RX by selectively using a plurality of communications.

The memory 206 stores a control program to be executed by the control unit 201. The memory 206 can also store the states of the TX and the RX (the transmitted power value, the received power value, and the like). For example, the state of the TX is obtained by the control unit 201, and as the state of the RX, information obtained by the control unit 301 of the RX can be received via the communication unit 204.

The switches 208 to 211 are controlled by the control unit 201 to switch between an open state and a short circuit state, thereby switching the configuration of the circuit of the TX. If the switch 208 is turned off and opened, the power transmission antenna 205 and the resonant capacitor 207 connected to the power transmission antenna 205 are disconnected from the power transmission unit 203. If the switch 208 is turned on and short-circuited, the power transmission antenna 205 and the resonant capacitor 207 are connected to the power transmission unit 203.

Each of the switches 209 to 211 is a switch capable of constructing a series resonant circuit including a corresponding resonant capacitor. If the switch 209 is turned on and short-circuited, the power transmission antenna 205 and the resonant capacitor 207 from a series resonant circuit. The series resonant circuit is configured to resonate at a specific frequency f1. At this time, a current flows to a closed circuit formed by the power transmission antenna 205, the resonant capacitor 207, and the switch 209. The resonant capacitor 212 is connected to the switch 210, and if the switch 210 is turned on and short-circuited, a series resonant circuit including the power transmission antenna 205, the resonant capacitor 207, and the resonant capacitor 212 is formed. The series resonant circuit is configured to resonate at a specific frequency f2. At this time, a current flows to a closed circuit formed by the power transmission antenna 205, the resonant capacitor 207, the resonant capacitor 212, and the switch 210. The resonant capacitor 213 is connected to the switch 211, and if the switch 211 is turned on and short-circuited, a series resonant circuit including the power transmission antenna 205, the resonant capacitor 207, and the resonant capacitor 213 can be formed. The series resonant circuit is configured to resonate at a specific frequency f3. At this time, a current flows to a closed circuit formed by the power transmission antenna 205, the resonant capacitor 207, the resonant capacitor 213, and the switch 211.

If the switch 208 is turned on and short-circuit, and the switches 209 to 211 are turned off and opened, power is supplied from the power transmission unit 203 to the power transmission antenna 205 and the resonant capacitor 207.

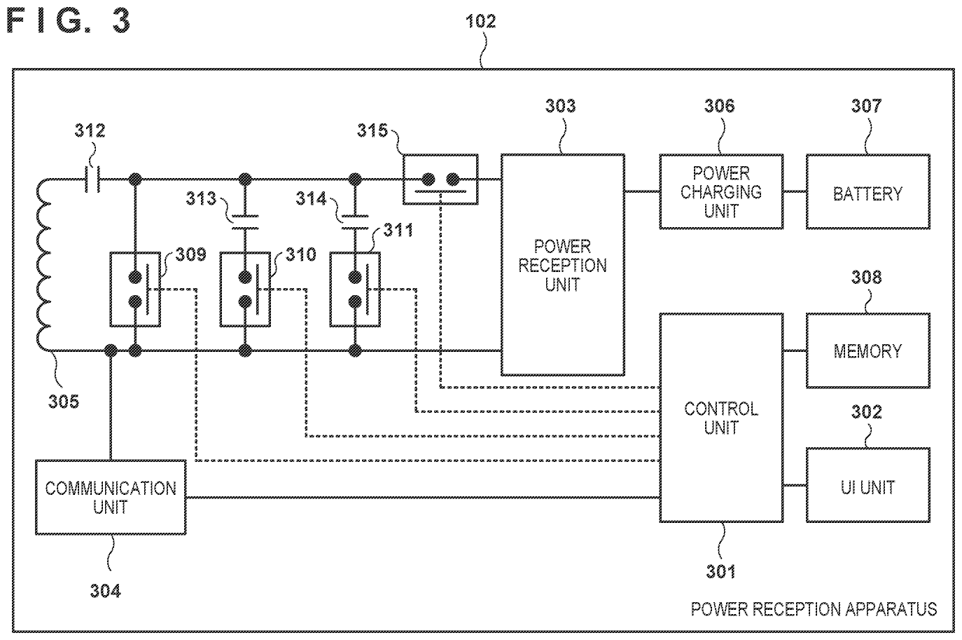

FIG. 3 is a block diagram showing an example of the configuration of the power reception apparatus 102 (RX) according to this embodiment. The RX includes, for example, a control unit 301, a UI (User Interface) unit 302, a power reception unit 303, a communication unit 304, a power reception antenna 305, a power charging unit 306, a battery 307, a memory 308, switches 309 to 311 and 315, and resonant capacitors 312 to 314. Note that two or more or all of the functional blocks shown in FIG. 3 as separate functional blocks may be implemented in the same chip. In addition, the plurality of functional blocks shown in FIG. 3 may be implemented as one hardware module.

The control unit 301 executes a control program stored in, for example, the memory 308, thereby executing control of the entire RX. That is, the control unit 301 executes control of each functional unit shown in FIG. 3. Also, the control unit 301 can perform control to execute an application other than wireless power transfer. For example, the control unit 301 is configured to include at least one processor such as a CPU or an MPU. Note that the control unit 301 may control the entire RX (if the RX is a smartphone, the entire smartphone) by cooperating with an OS (Operating System) under execution. In addition, the control unit 301 may be formed by hardware such as an ASIC. The control unit 301 may also be configured to include an array circuit such as an FPGA compiled to execute predetermined processing. The control unit 301 stores, in the memory 308, information that should be stored during execution of various kinds of processing. Also, the control unit 301 can measure a time using a timer (not shown).

The UI unit 302 performs various kinds of outputs to the user. The various kinds of outputs include, for example, operations such as screen display, blinking or color change of an LED (Light Emitting Diode), voice output by a speaker, and a vibration of the RX main body. Hence, the UI unit 302 is configured to include, for example, a liquid crystal panel, a speaker, a vibration motor, and the like. Note that the UI unit 302 may include, for example, an input mechanism configured to accept an operation from the user.

The power reception unit 303 obtains, via the power reception antenna 305, alternating current power (an alternating voltage and an alternating current) generated by electromagnetic induction based on the electromagnetic wave radiated from the power transmitting antenna 205 of the TX. The power reception unit 303 converts the alternating current power into direct current power or alternating current power of a predetermined frequency, and outputs the converted power to the power charging unit 306 that performs processing for charging the battery 307. To do this, the power reception unit 303 includes, for example, a rectification unit and a voltage control unit necessary for supplying power to the loads in the RX. The above-described GP is electric energy guaranteed to be output from the power reception unit 303. The power reception unit 303 has a power supply capability of supplying power with which the power charging unit 306 charges the battery 307 and outputting power of 15 W to the power charging unit 306.

The communication unit 304 performs communication with the communication unit 204 provided in the TX for power reception control based on the WPC standard as described above. The communication unit 304 demodulates an electromagnetic wave input from the power reception antenna 305, thereby obtaining information transmitted from the TX. Also, the communication unit 304 load-modulates the input electromagnetic wave and thus superimposes a signal concerning information to be transmitted to the TX on the electromagnetic wave, thereby transmitting the information to the TX. Note that the communication unit 304 may communicate with the TX by communication using an antenna different from the power reception antenna 305 and based on a standard different from the WPC standard, or may communicate with the TX by selectively using a plurality of communications.

The memory 308 stores a control program to be executed by the control unit 301. The memory 308 also stores the states of the TX and the RX. For example, the state of the RX is obtained by the control unit 301, and as the state of the TX, information obtained by the control unit 201 of the TX can be received via the communication unit 304.

The switches 309 to 311 and 315 are controlled by the control unit 301 to switch between an open state and a short circuit state, thereby switching the configuration of the circuit of the RX.

If the switch 309 is turned on and short-circuited, the power reception antenna 305 and the resonant capacitor 312 connected to the power reception antenna 305 form a series resonant circuit. The series resonant circuit is configured to resonate at a specific frequency f4. At this time, a current flows to a closed circuit formed by the power reception antenna 305, the resonant capacitor 312, and the switch 309. The resonant capacitor 313 is connected to the switch 310, and if the switch 310 is turned on and short-circuited, the power reception antenna 305, the resonant capacitor 312, and the resonant capacitor 313 form a series resonant circuit. The series resonant circuit is configured to resonate at a specific frequency f5. At this time, a current flows to a closed circuit formed by the power reception antenna 305, the resonant capacitor 312, the resonant capacitor 313, and the switch 310. The resonant capacitor 314 is connected to the switch 311, and if the switch 311 is turned on and short-circuited, the power reception antenna 305, the resonant capacitor 312, and the resonant capacitor 314 form a series resonant circuit. The series resonant circuit is configured to resonate at a specific frequency f6. At this time, a current flows to a closed circuit formed by the power reception antenna 305, the resonant capacitor 312, the resonant capacitor 314, and the switch 311.

If the switches 309 to 311 are turned off and opened, power received by the power reception antenna 305 and the resonant capacitor 312 is supplied to the power reception unit 303.

The switch 315 is used to control whether to supply the received power to the battery that is a load. Also, the switch 315 has a function of controlling the value of the load. If the switch 315 is turned on and short-circuited, the power received by the power reception antenna 305 is supplied to the battery 307 via the power charging unit 306. If the switch 315 is turned off and opened, the power received by the power reception antenna 305 is not supplied to the battery 307. Note that the switch 315 is arranged between the resonant capacitor 312 and the power reception unit 303 in FIG. 3, but may be arranged between the power reception unit 303 and the power charging unit 306. Alternatively, the switch 315 may be arranged between the power charging unit 306 and the battery 307. In FIG. 3, the switch 315 is shown as one block. However, the switch 315 may be implemented as a part of the power charging unit 306 or as a part of the power reception unit 303.

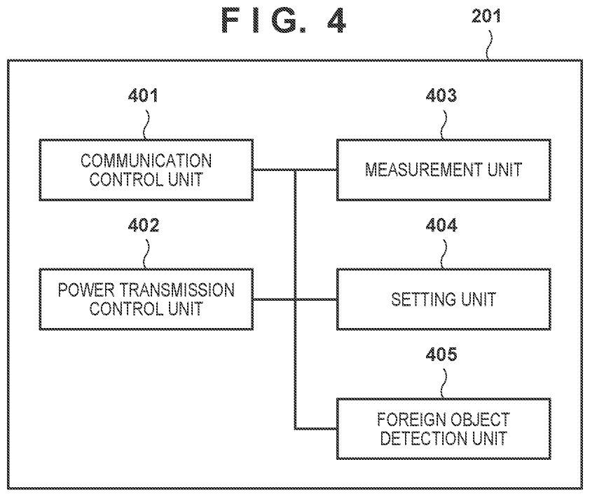

The functions of the control unit 201 of the TX will be described next with reference to FIG. 4. The control unit 201 is configured to include, for example, a communication control unit 401, a power transmission control unit 402, a measurement unit 403, a setting unit 404, and a foreign object detection unit 405. The communication control unit 401 performs control communication with the RX based on the WPC standard via the communication unit 204. The power transmission control unit 402 controls the power transmitting unit 203 to control power transmission to the RX. The measurement unit 403 measures a waveform attenuation index to be described later. Also, the measurement unit 403 measures power to be transmitted to the RX via the power transmission unit 203, and measures average transmitted power per unit time. The measurement unit 403 also measures the Q-Factor of the power transmission antenna 205. Based on the waveform attenuation index measured by the measurement unit 403, the setting unit 404 sets a threshold to be used for foreign object detection by, for example, calculation processing. The foreign object detection unit 405 has a foreign object detection function by the Power Loss method, a foreign object detection function by the Q-Factor measuring method, and a function of performing foreign object detection by a waveform attenuation method. The foreign object detection unit 405 may have a function of performing foreign object detection processing using another method. For example, the foreign object detection unit 405 in the TX having an NFC (Near Field Communication) communication function may perform foreign object detection processing using a counter device detection function by the NFC standard. As a function other than foreign object detection, the foreign object detection unit 405 can also detect a change of the state on the TX. For example, the TX can detect an increase/decrease of the number of power reception apparatuses 102 on the TX.

The setting unit 404 sets a threshold serving as a reference for the TX to determine the presence/absence of a foreign object when performing foreign object detection by the Power Loss method, the Q-Factor measuring method, or the waveform attenuation method. The setting unit 404 may have a function of setting a threshold serving as a criterion for determining the presence/absence of a foreign object, which is necessary in foreign object detection processing using another method. The foreign object detection unit 405 can perform foreign object detection processing based on the threshold set by the setting unit 404 and the waveform attenuation index, transmitted power, or Q-Factor measured by the measurement unit 403.

The functions of the communication control unit 401, the power transmission control unit 402, the measurement unit 403, the setting unit 404, and the foreign object detection unit 405 are implemented as programs that operate in the control unit 201. The functional units can each be configured as an independent program. The functional units can operate concurrently while establishing synchronization between the programs by event processing or the like. Two or more of the processing units may be implemented by one program.

(Procedure of Processing for Power Transfer According to WPC Standard)

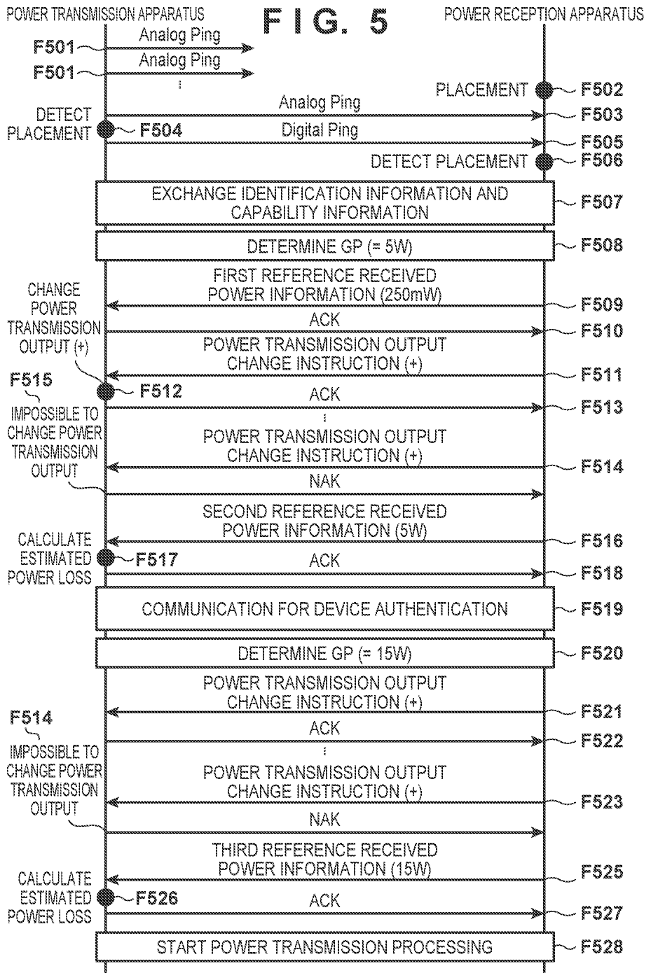

As described above, the WPC standard defines the Selection phase, the Ping phase, the I&C phase, the Negotiation phase, the Calibration phase, and the Power Transfer phase. The operations of the power transmission apparatus 101 and the power reception apparatus 102 in these phases will be described below with reference to FIG. 5.

To detect an object existing in the power transmission enable range, the TX repetitively intermittently transmits the Analog Ping of the WPC standard (F501). The TX executes processing defined as the Selection phase and the Ping phase of the WPC standard, and waits for placement of the RX. For power charging, the user of the RX brings the RX (for example, a smartphone) close to the TX (F502). For example, the user places the RX on the TX, thereby bringing the RX close to the TX. Upon detecting that an object exists in the power transmission enable range (F503 and F504), the TX transmits the Digital Ping of the WPC standard (F505). Upon receiving the Digital Ping, the RX can grasp that the TX has detected the RX (F506). In addition, upon receiving a predetermined response to the Digital Ping, the TX determines that the detected object is the RX, and that the RX is placed on the power charging table 103.

Upon detecting the placement of the RX, the TX obtains identification information and capability information from the RX by communication in the I&C phase defined by the WPC standard (F507). Here, the identification information of the RX includes a Manufacturer Code and a Basic Device ID. The capability information of the RX includes an information element capable of specifying the version of the WPC standard that the RX supports, a Maximum Power Value that is a value specifying maximum power that the RX can supply to the load, and information representing whether the RX has the Negotiation function of the WPC standard. Note that the TX may obtain the identification information and the capability information of the RX by a method other than the communication in the I&C phase of the WPC standard. Also, the identification information may be another arbitrary identification information capable of identifying the individual of the RX, such as a Wireless Power ID. As the capability information, information other than those described above may be included.

Next, the TX decides the value of GP with the RX by communication in the Negotiation phase defined by the WPC standard (F508). Note that in F508, not the communication in the Negotiation phase of the WPC standard but another procedure for deciding GP may be executed. Also, if information representing that the RX does not support the Negotiation phase is obtained (in, for example, F507), the TX may be set the value of GP to a small value (for example, defined by the WPC standard in advance) without performing communication in the Negotiation phase. In this embodiment, GP=5 watt (5 W) is decided in F508.

After decision of GP, the TX executes Calibration based on the GP. In the Calibration processing, first, the RX transmits, to the TX, information (this information will be referred to as “first reference received power information” hereinafter) including received power in the light load state (a load disconnected state or a load state in which the transmitted power is equal to or less than a first threshold) (F509). In this embodiment, the first reference received power information is the received power information of the RX when the transmitted power of the TX is 250 mW. The first reference received power information is notified using a Received Power Packet (mode1) defined by the WPC standard. However, another message may be used for the notification. The TX determines, based on the power transmission state of the self-apparatus, whether to accept the first reference received power information. If the first reference received power information is accepted, the TX transmits an acknowledgement (ACK) to the RX. If the first reference received power information is not accepted, the TX transmits a negative acknowledgement (NAK) to the RX.

Upon receiving the ACK from the TX (F510), the RX performs processing for transmitting, to the TX, information (this information will be referred to as “second reference received power information” hereinafter) including received power in a load connected state (a maximum load state or a state in which the transmitted power is equal to or more than a second threshold). In this embodiment, since the GP is 5 W, the second reference received power information is, for example, the received power information of the RX when the transmitted power of the TX is 5 W. Here, the second reference received power information is notified using a Received Power Packet (mode2) defined by the WPC standard. However, this notification may be made using another message. To increase the transmitted power from the TX up to 5 W, the RX transmits a power transmission output change instruction including a value (positive value) corresponding to the transmitted power increase (F511). The TX receives the power transmission output change instruction, and if the transmitted power can be increased, the TX responds by an ACK to the RX and increases the transmitted power (F512 and F513). The second reference received power information is received power information when the transmitted power of the TX is 5 W. Hence, upon receiving a power increase request more than 5 W from the RX, the TX responds to the power transmission output change instruction by a NAK, thereby notifying the RX that the transmitted power cannot be changed (F514). It is therefore possible to suppress power transmission more than specified. Upon receiving the NAK from the TX, the RX determines that the transmitted power has reached the specified value, and transmits, to the TX, the second reference received power information concerning the received power in the load connected state (F516). Based on the received power values indicated by the first reference received power information and the second reference received power information and the transmitted power values of the TX when these received power values are obtained, the TX can calculate power loss amounts between the TX and the RX in the load disconnected state and in the load connected state. In addition, by interpolation based on the relationship between the power loss amounts, the TX can estimate power loss values between the TX and the RX for all transmitted powers (here, from 250 mW to 5 W) that the TX can take (F517). The TX transmits an ACK to the second reference received power information from the RX (F518), and completes the Calibration processing. In a state in which the TX determines that power charging processing of the RX can be started, power transmission processing to the RX is started, and power charging of the RX is started.

Note that before the start of power transmission processing, the TX and the RX may perform device authentication processing (F519), and if it is determined that these can handle larger GP, the GP may be reset to a larger value, for example, 15 W (F520). In this case, to increase the transmitted power of the TX to 15 W, the RX and the TX increase the transmitted power of the TX using the power transmission output change instruction, an ACK, and an NAK (F521 to F524). If GP=15 W, the TX and the RX execute Calibration processing again. That is, the RX transmits information (this information will be referred to as “third reference received power information” hereinafter) including received power in the load connected state of the RX when the transmitted power of the TX is 15 W (F525). The TX executes Calibration based on the received powers indicated by the first reference received power information, the second reference received power information, and the third reference received power information and the transmitted powers when the received powers are obtained. Thus, the TX can estimate power loss amounts between the TX and the RX for all transmitted powers (here, from 250 mW to 15 W) that the TX can take (F526). The TX transmits an ACK to the third reference received power information from the RX (F527), and completes the Calibration processing. After that, in a state in which the TX determines that power charging processing of the RX can be started, power transmission processing to the RX is started, and power charging of the RX is started (F528).

In the Power Transfer phase, the TX transmits power to the RX. Also, in the Power Transfer phase, foreign object detection by the above-described Power Loss method is performed. Here, in foreign object detection by the Power Loss method, the foreign object detection can be performed while continuing power transmission. Hence, the power transmission efficiency can be kept high. However, if the power transmission apparatus 101 is transmitting large power, the accuracy of foreign object detection may lower. For this reason, if only foreign object detection using the Power Loss method is performed, there is the possibility of a detection error of a foreign object or the possibility of a determination error in which although a foreign object exists, it is determined that no foreign object exists. In particular, the Power Transfer phase is a phase in which the TX performs power transmission. If a foreign object exists near the TX and the RX during power transmission, heat generated from the foreign object increases. For this reason, it is necessary to improve the foreign object detection accuracy in this phase. Hence, in this embodiment, to improve the foreign object detection accuracy, foreign object detection is further executed using the following waveform attenuation method as a foreign object detection method different from the Power Loss method.

(Foreign Object Detection Method by Waveform Attenuation Method)

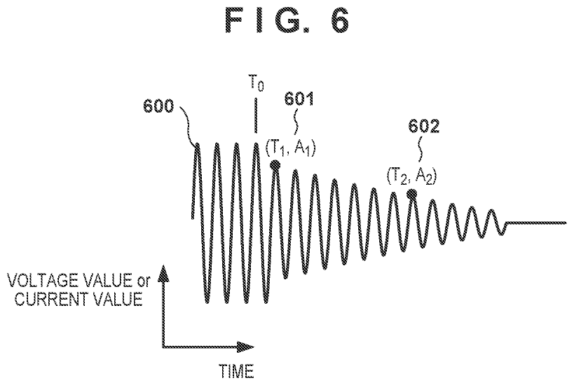

In the Power Transfer phase, the power transmission apparatus 101 transmits power to the power reception apparatus 102. At this time, if foreign object detection can be performed using a power transmission waveform (the waveform of a voltage or the waveform of a current) concerning the power transmission, a foreign object can be detected without using a newly defined foreign object detection signal or the like. As such a method, in this embodiment, a method of performing foreign object detection based on the attenuation state of a power transmission waveform (this method will be called a “waveform attenuation method”) is used. The principle of foreign object detection by the waveform attenuation method will be described with reference to FIG. 6. Foreign object detection using a power transmission waveform associated with power transmission from the power transmission apparatus 101 (TX) to the power reception apparatus 102 (RX) will be described here as an example.

Referring to FIG. 6, the waveform shows the change of a voltage value 600 of a high-frequency voltage applied to the power transmission antenna 205 of the TX (to be simply referred to as a voltage value hereinafter) along with the elapse of time. The abscissa of FIG. 6 represents time, and the ordinate represents the voltage value. The TX that is transmitting power to the RX via the power transmission antenna 205 stops power transmission at time T₀. That is, at time T₀, power supply from the power supply unit 202 for power transmission is stopped. The frequency of the power transmission waveform associated with the power transmission from the TX is a predetermined frequency, and this is, for example, a fixed frequency from 85 kHz to 205 kHz used in the WPC standard. A point 601 is a point on the envelope of the high-frequency voltage, and represents the voltage value at time T₁. In FIG. 6, (T₁, A₁) represents that the voltage value at time T₁ is A₁. Similarly, a point 602 is a point on the envelope of the high-frequency voltage, and represents the voltage value at time T₂. In FIG. 6, (T₂, A₂) represents that the voltage value at time T₂ is A₂. The quality coefficient (Q-Factor) of the power transmission antenna 205 can be specified based on the temporal change of the voltage value from time T₀. For example, based on the times, voltage values, and frequencies f of high-frequency voltages at the points 601 and 602 on the envelope of the voltage value, the Q-Factor is calculated by

Q=π(T₂−T₁)/ln(A₁/A₂) (1)

This Q-Factor lowers if a foreign object exists near the TX and the RX. This is because if a foreign object exists, an energy loss is caused by the foreign object. Hence, focusing on the inclination of attenuation of the voltage value, since an energy loss due to a foreign object occurs in a case where a foreign object exists, as compared to a case where a foreign object is absent, the inclination of the line that connects the points 601 and 602 becomes steep, and the attenuation rate of the amplitude of the waveform becomes high. That is, in the waveform attenuation method, the presence/absence of a foreign object is determined based on the attenuation state of the voltage value between the point 601 and the point 602. In the waveform attenuation method, the actual determination of the presence/absence of a foreign object can be performed by comparing an arbitrary numerical value corresponding to the attenuation state. For example, the determination can be performed using the above-described Q-Factor. In this case, that the Q-Factor lowers means that the waveform attenuation rate (the degree of decrease of the amplitude of the waveform per unit time) becomes high. Also, the determination may be performed using the inclination of the line that connects the points 601 and 602, which is calculated by (A₁−A₂)/(T₂−T₁). Alternatively, if the times (T₁ and T₂) to observe the attenuation state of the voltage value are fixed, the determination may be performed using the value (A₁−A₂) representing the difference between the voltage values, or the value (A₁/A₂) representing the ratio of the voltage values. If the voltage value A₁ immediately after the stop of power transmission is constant, the determination can be performed using the value of the voltage value A₂ after the elapse of a predetermined time. Also, the determination may be performed using the value of the time (T₂−T₁) until the voltage value A₁ becomes the predetermined voltage value A₂.

As described above, the presence/absence of a foreign object can be determined based on the attenuation state of the voltage value during power transmission stop period, and there exist a plurality of values representing the attenuation state. In this embodiment, the values representing the attenuation state will be called “waveform attenuation indices”. For example, the Q-Factor calculated by equation (1), as described above, is a value representing the attenuation state of the voltage value associated with power transmission and is included in the “waveform attenuation indices”. All the waveform attenuation indices are values corresponding to waveform attenuation rates. Note that, in the waveform attenuation method, the waveform attenuation rate itself may be measured as a “waveform attenuation index”. A case where the waveform attenuation rate is used as the waveform attenuation index will mainly be described below. The contents of this embodiment can similarly be applied to any case where another waveform attenuation index is used.

Note that even if a current value flowing to the power transmission antenna 205 is plotted along the ordinate in FIG. 6, the attenuation state of the current value during the power transmission stop period changes depending on the presence/absence of a foreign object, as in the case of the voltage value. If a foreign object exists, the waveform attenuation rate is larger than in a case where no foreign object exists. Hence, the foreign object can be detected by applying the above-described method concerning the temporal change of the current value flowing to the power transmission antenna 205. That is, it is possible to determine the presence/absence of a foreign object and detect a foreign object using, as a waveform attenuation index, a Q-Factor obtained from the current waveform, the inclination of attenuation of the current value, the difference between the current values, the ratio of the current values, the absolute value of the current value, and a time until a predetermined current value is obtained. Also, foreign object detection based on both the attenuation state of the voltage value and the attenuation state of the current value may be performed by, for example, determining the presence/absence of a foreign object using an evaluation value calculated from the waveform attenuation index of the voltage value and the waveform attenuation index of the current value. Note that in the above-described example, the waveform attenuation index during the period when the TX temporarily stops power transmission is measured. However, the waveform attenuation index during the period when the TX temporarily lowers power supplied from the power supply unit 202 from a predetermined power level to a lower power level may be measured.

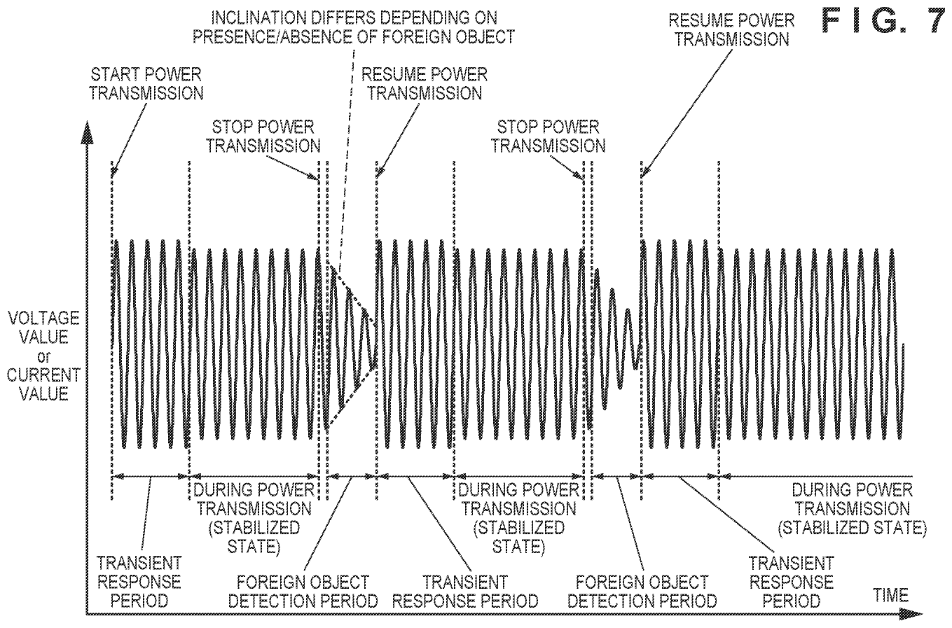

A method of performing foreign object detection based on a power transmission waveform during power transmission using the waveform attenuation method will be described with reference to FIG. 7. FIG. 7 show a power transmission waveform when foreign object detection is performed by the waveform attenuation method. The abscissa represents time, and the ordinate represents the voltage value of the power transmission antenna 205. Note that the ordinate may represent the current value of a current flowing to the power transmission antenna 205, as in FIG. 6. Note that during a transient response period immediately after the TX starts power transmission, the power transmission waveform is assumed to be unstable. For this reason, during the transient response period, the RX controls not to perform communication (communication by load modulation) with the TX. In addition, the TX controls not to perform communication (communication by frequency shift keying) with the RX. The TX temporarily stops power transmission at the timing of performing foreign object detection. Since the amplitude of the power transmission waveform is attenuated by stopping power transmission, the TX calculates the waveform attenuation rate of the attenuated waveform. If the calculated waveform attenuation rate exceeds a predetermined threshold, the TX determines that a foreign object exists. If no foreign object is detected during a predetermined foreign object detection period, the TX resumes power transmission after the period. After power transmission is resumed, the TX repetitively executes the above-described waiting in the transient response period, specifying of the foreign object detection timing, power transmission stop, and foreign object detection processing. Thus, in the Power Transfer phase, foreign object detection can be performed by the waveform attenuation method in addition to the Power Loss method.

(Processing of Power Transmission Apparatus in Case where Waveform Attenuation Method is Applied to WPC Standard)

Processing executed by the power transmission apparatus 101 when performing foreign object detection by applying the waveform attenuation method to the WPC standard will be described next. When executing foreign object detection by the waveform attenuation method, the power transmission apparatus 101 measures, in advance, the waveform attenuation rate in a state in which no foreign object exists and calculates a threshold based on the waveform attenuation rate as a reference. After that, the power transmission apparatus 101 executes foreign object detection by the waveform attenuation method, and if the measured waveform attenuation rate is larger than the threshold, determines that “a foreign object exists” or “there is a possibility that a foreign object exists”. On the other hand, if the measured waveform attenuation rate is smaller than the threshold, the power transmission apparatus 101 determines that “no foreign object exists” or “a possibility that no foreign object exists is high”.

Note that since in the waveform attenuation method, the power transmission apparatus 101 temporarily stops power transmission, measures the attenuation rate of the power transmission waveform, and performs foreign object detection, the power transmission efficiency may lower due to the temporary stop of power transmission. On the other hand, even during transmission of large power, foreign object detection can accurately be performed by the waveform attenuation method. That is, even in a situation where it is difficult to accurately detect a foreign object by the Power Loss method, a foreign object can accurately be detected using the waveform attenuation method.

In the above-described example, when executing foreign object detection using the waveform attenuation method, the waveform attenuation rate in a state in which no foreign object exists is measured before the start of power transmission, and a threshold is calculated based on the waveform attenuation rate as a reference. Hence, foreign object detection may be executed using a threshold obtained from the waveform attenuation rate measured at a timing after the start of power transmission when it is estimated that no foreign object exists. For example, the TX confirms, by the Power Loss method during power transmission, that no foreign object exists, executes first waveform attenuation rate measurement, and calculates a threshold based on the measured waveform attenuation rate as a reference. Since the first waveform attenuation rate measurement is executed immediately after it is confirmed by the Power Loss method that no foreign object exists, the measured waveform attenuation rate can be considered as a waveform attenuation rate in a state in which no foreign object exists. Next, the TX resumes power transmission, and executes second waveform attenuation rate measurement at a timing judged as a timing to perform foreign object detection. The measurement result of the second waveform attenuation rate measurement is compared with the measurement result of the first waveform attenuation rate measurement or the threshold calculated based on the measurement result as a reference, thereby determining the presence/absence of a foreign object. That is, when executing foreign object detection by the waveform attenuation method, the waveform attenuation rate measured at that time may be compared with a waveform attenuation rate before that in a state in which no foreign object exists or a corresponding threshold.

Also, in the above-described example, the frequency of the power transmission waveform associated with power transmission from the power transmission apparatus 101 is a fixed frequency. However, the above-described processing for foreign object detection may be executed at each of a plurality of frequencies, and the presence/absence of a foreign object may be determined by combining the results. If foreign object detection is performed using not only the waveform attenuation rate at one frequency but the waveform attenuation rates at the plurality of frequencies, more accurate foreign object detection can be performed. This will be described later.

Also, in this embodiment, immediately after the power transmission apparatus 101 stops power transmission, or immediately after the power transmission apparatus 101 starts power transmission, the power transmission waveform becomes unstable due to the transient response. Hence, a standby time is provided before a shift to each operation. Thus, the instability of the power transmission waveform is caused by the abrupt start or abrupt stop of power transmission. Hence, to alleviate such instability of the power transmission waveform, the power transmission apparatus 101 may control to increase the transmitted power stepwise when starting power transmission or decrease the transmitted power stepwise when stopping power transmission. Note that the power transmission apparatus 101 may perform only one of the increase and the decrease of the transmitted power stepwise, or may perform both stepwise.

(Foreign Object Detection Method by Waveform Attenuation Method Using Plural Frequencies)

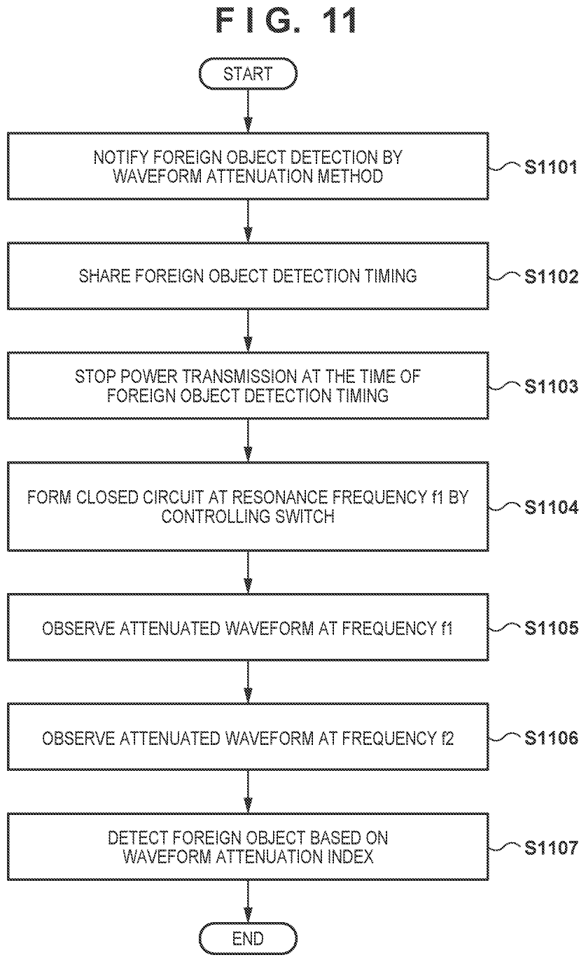

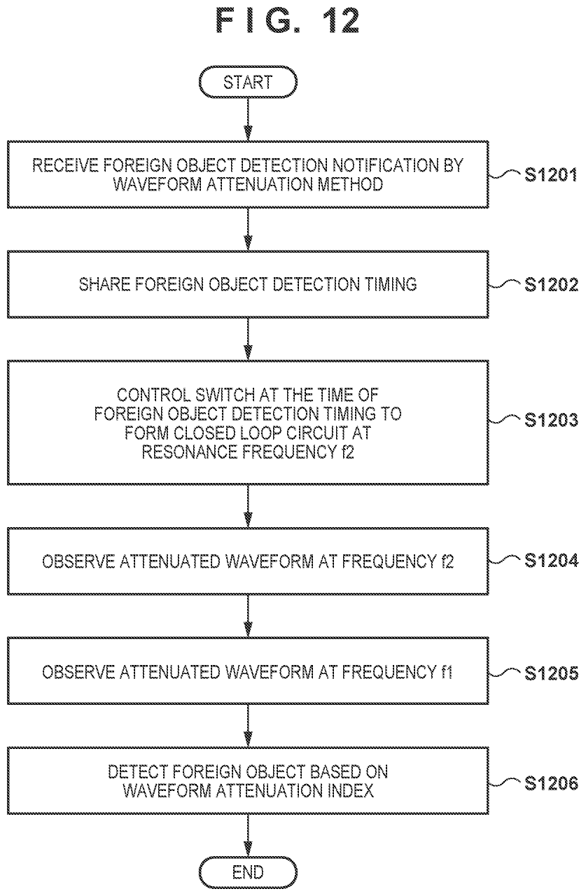

A foreign object mixed between the power transmission apparatus 101 and the power reception apparatus 102 causes heat generation during power transmission. For this reason, if a foreign object is mixed, the power transmission apparatus 101 needs to early detect the foreign object, and perform transmitted power control such as stop of power transmission or decrease of transmitted power. The foreign object mixed between the power transmission apparatus 101 and the power reception apparatus 102 can have various sizes and shapes. In the waveform attenuation method described with reference to FIGS. 6 and 7, the power transmission apparatus 101 transmits power at a predetermined frequency, temporarily stops the power transmission, and detects a foreign object from the waveform attenuation rate of the power transmission waveform. However, energy consumed by the foreign object can change depending on the frequency. That is, it is assumed that if a foreign object A exists, the waveform attenuation rate of the waveform at a frequency X is high, but the waveform attenuation rate of the waveform at a frequency Y is low, and if a foreign object B exists, the waveform attenuation rate of the waveform at the frequency X is low, but the waveform attenuation rate of the waveform at the frequency Y is high. This is because the frequency characteristic of energy consumed by a foreign object changes depending on the size and shape of the foreign object. In the above-described example, if the frequency Y is used for the waveform, even if the foreign object A exists, the waveform attenuation rate may be low, and it may erroneously be determined that “no foreign object exists” even if the foreign object A exists. To prevent such a determination error, for the foreign object A, it is effective to perform foreign object detection using the waveform attenuation rate of the waveform at the frequency X as well, instead of performing foreign object detection using only the waveform attenuation rate of the waveform at the frequency Y That is, if foreign object detection is performed by measuring the attenuation rates of the waveform of a voltage or current corresponding to a plurality of frequencies, the probability of occurrence of a determination error can be reduced. Processing executed by the power transmission apparatus 101 and processing executed by the power reception apparatus 102 when executing such foreign object detection will be described below with reference to FIGS. 11 and 12. FIG. 11 shows an example of the procedure of processing executed by the power transmission apparatus 101, and FIG. 12 shows an example of the procedure of processing executed by the power reception apparatus 102.

During power transmission to the power reception apparatus 102, the power transmission apparatus 101 notifies the power reception apparatus 102, by communication using a predetermined packet, that foreign object detection by the waveform attenuation method should be executed (steps S1101 and S1102). Upon receiving the packet, the power reception apparatus 102 transmits a command of a foreign object detection execution request to the power transmission apparatus 101. This command can include time information for notifying the power transmission apparatus 101 of the time (timing) of executing foreign object detection. Note that the time at which foreign object detection should be executed may be notified from the power transmission apparatus 101 to the power reception apparatus 102 using the above-described packet. Thus, the power transmission apparatus 101 and the power reception apparatus 102 share the information of the timing of executing foreign object detection (steps S1102 and S1202). The power transmission apparatus 101 stops power transmission at the time of executing foreign object detection (step S1103). The power transmission apparatus 101 turns on and short-circuits the switch 209, thereby forming a closed loop circuit formed by the power transmission antenna 205, the resonant capacitor 207, and the switch 209, which resonates at the frequency f1 (step S1104). Note that the power transmission apparatus 101 may stop power transmission after the switch 209 is turned on and short-circuited. Also, the power transmission apparatus 101 may stop power transmission at the same time as the switch 209 is turned on and short-circuited. On the other hand, at the time of executing foreign object detection, the power reception apparatus 102 turns on and short-circuits the switch 309, thereby forming a closed loop circuit formed by the power reception antenna 305, the resonant capacitor 312, and the switch 309, which resonates at the frequency f2 (step S1203). Thus, the attenuated waveform at the frequency f1 is observed in the power transmission antenna 205 and the resonant capacitor 207 of the power transmission apparatus 101 (step S1105), and the attenuated waveform at the frequency f2 is observed in the power reception antenna 305 and the resonant capacitor 312 of the power reception apparatus 102 (step S1204).

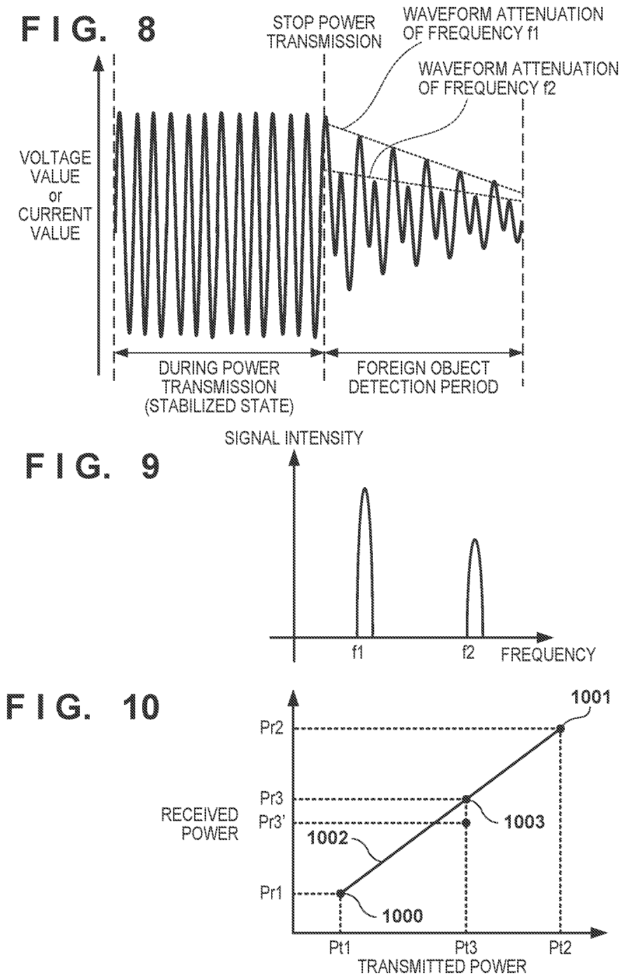

Here, the power transmission antenna 205 and the power reception antenna 305 are electromagnetically connected to each other such that wireless power transfer and wireless communication are performed by these. Hence, the attenuated waveform at the frequency f2 can be observed even by the circuit formed by the power transmission antenna 205 and the resonant capacitor 207 and existing in the power transmission apparatus 101 (step S1106). Also, the attenuated waveform at the frequency f1 can be observed even by the circuit formed by the power reception antenna 305 and the resonant capacitor 312 and existing in the power reception apparatus 102 (step S1205). FIG. 8 schematically shows the attenuated waveform be observed by the circuit formed by the power transmission antenna 205 and the resonant capacitor 207 of the power transmission apparatus 101 or the attenuated waveform be observed by the circuit formed by the power reception antenna 305 and the resonant capacitor 312 of the power reception apparatus 102. If the power transmission apparatus 101 stops power transmission and turns on and short-circuits the switch 209, and the power reception apparatus 102 turns on and short-circuits the switch 309, the mixed waveform of the frequency f1 and the frequency f2 can be observed during the foreign object detection period, as shown in FIG. 8. As described with reference to FIGS. 6 and 7, the power transmission apparatus 101 and the power reception apparatus 102 can detect the presence/absence of a foreign object based on this waveform attenuation index (steps S1107 and S1206). The power transmission apparatus 101 and the power reception apparatus 102 perform the operations as described above, thereby observing waveform attenuation of not the waveform of one frequency but the mixed wave of two frequencies. The power transmission apparatus 101 and the power reception apparatus 102 observe the waveform attenuation index of the mixed wave, thereby improving the accuracy of foreign object detection.

A method of detecting a foreign object from the mixed wave of two frequencies will be described. As shown in FIG. 8, during the foreign object detection period, a waveform in which two frequencies are mixed is observed. The attenuation rate of the waveform at each of f1 and f2 can be specified by observing the time waveform of the attenuated waveform of the mixed wave. For example, as shown in FIG. 8, the attenuation state of the waveform at the frequency f1 and the attenuation state of the waveform at the frequency f2 can be specified. The method of specifying a waveform attenuation index from the attenuated waveform at each of the frequencies f1 and f2 is the same as described above in association with FIGS. 6 and 7.

The power transmission apparatus 101 or the power reception apparatus 102 calculates, in advance, waveform attenuation indices for the frequencies f1 and f2 in a state in which no foreign object exists. The power transmission apparatus 101 or the power reception apparatus 102 calculates a threshold for the frequency f1 based on the waveform attenuation index for the frequency f1 in a state in which no foreign object exists, and calculates a threshold for the frequency f2 based on the waveform attenuation index for the frequency f2 in a state in which no foreign object exists. The power transmission apparatus 101 or the power reception apparatus 102 compares the waveform attenuation index specified from the observed attenuated waveform of the frequency f1 with the threshold calculated for the frequency f1. In addition, the power transmission apparatus 101 or the power reception apparatus 102 compares the waveform attenuation index specified from the observed attenuated waveform of the frequency f2 with the threshold calculated for the frequency f2. If the waveform attenuation index for the frequency f1 exceeds the threshold, and the waveform attenuation index for the frequency f2 exceeds the threshold, the power transmission apparatus 101 or the power reception apparatus 102 determines that “a foreign object exists” or “a possibility that a foreign object exists is high”. Alternatively, if the waveform attenuation index for the frequency f1 exceeds the threshold, or the waveform attenuation index for the frequency f2 exceeds the threshold, the power transmission apparatus 101 or the power reception apparatus 102 may determine that “a foreign object exists” or “a possibility that a foreign object exists is high”. That is, if the waveform attenuation index for one of the frequencies f1 and f2 exceeds the threshold, the power transmission apparatus 101 or the power reception apparatus 102 can determine that “a foreign object exists” or “a possibility that a foreign object exists is high”. This makes it possible to perform foreign object detection more reliably.

Note that as described above, the mixed wave of the frequencies f1 and f2 can be observed by both the power transmission apparatus 101 and the power reception apparatus 102. Hence, the above-described “method of detecting a foreign object from the mixed wave of two frequencies” can be executed by both the power transmission apparatus 101 and the power reception apparatus 102. In the above-described embodiment, an example in which the threshold for the frequency f1 and the threshold for the frequency f2 are separately set has been described. However, the present disclosure is not limited to this, and identical values may be set as these thresholds. Also, when the switch 209 is turned on, the power transmission apparatus 101 may turn off the switch 208 to disconnect the power transmission antenna 205 and the resonant capacitor 207 from the power transmission unit 203. This makes it possible to remove the influence of the power transmission unit when performing foreign object detection using the waveform attenuation method and more accurately detect a foreign object. When the switch 309 is turned on, the power reception apparatus 102 may turn off the switch 315 to disconnect the power reception antenna 305 and the resonant capacitor 312 from the power reception unit 303. This makes it possible to remove the influence of the power transmission unit when performing foreign object detection using the waveform attenuation method and more accurately detect a foreign object.

At least one of the power transmission apparatus 101 and the power reception apparatus 102 operates as described above to perform foreign object detection based on voltage or current characteristics at a plurality of frequencies (here, the waveform attenuation indices of attenuated waveforms), thereby more accurately detecting a foreign object.

(Modification 1 of Foreign Object Detection Method by Waveform Attenuation Method Using Plural Frequencies)

In the above-described example, the method of detecting a foreign object based on the time waveform (attenuated waveform) at the frequency f1 and the time waveform (attenuated waveform) at the frequency f2 has been described. In this modification, a foreign object is detected based on not the time waveforms at the frequencies f1 and f2 but signal spectra at the frequencies f1 and f2. That is, in a case where foreign object detection is performed based on the time waveform, if noise is mixed, and the time waveform is disturbed, it may be not easy to specify the waveform attenuation index. On the other hand, in this modification, arithmetic processing is executed for the time waveform to specify a signal spectrum (a signal intensity and a frequency spectrum) for each frequency, and a foreign object is detected based on the signal spectrum, thereby enabling execution of foreign object detection robust against disturbance of the time waveform.

In this modification, for example, the power transmission apparatus 101 or the power reception apparatus 102 executes arithmetic processing for the waveform in an analysis target section as shown in FIG. 8, thereby converting at least the components of the frequencies f1 and f2 in the frequency domain into a specifiable format. The power transmission apparatus 101 or the power reception apparatus 102, for example, Fourier-transforms the waveform in the analysis target section, thereby specifying the signal spectrum (the signal intensity and the frequency spectrum) for each frequency in the analyses target section. The signal spectrum (the signal intensity and the frequency spectrum) for each frequency in the analyses target section is specified as shown in, for example, FIG. 9. If a foreign object exists between the power transmission apparatus 101 and the power reception apparatus 102, energy is consumed by the foreign object. Hence, the intensity of the signal spectrum as shown in FIG. 9 is also weakened.

For this reason, the power transmission apparatus 101 or the power reception apparatus 102 performs foreign object detection using this characteristic. For example, the power transmission apparatus 101 or the power reception apparatus 102 specifies, in advance, signal spectra for the frequencies f1 and f2 in a state in which no foreign object exists. The power transmission apparatus 101 or the power reception apparatus 102 calculates a threshold for the frequency f1 based on the signal spectrum for the frequency f1 in a state in which no foreign object exists. In addition, the power transmission apparatus 101 or the power reception apparatus 102 calculates a threshold for the frequency f2 based on the signal spectrum for the frequency f2 in a state in which no foreign object exists. The power transmission apparatus 101 or the power reception apparatus 102 compares the signal spectrum specified from the observed attenuated waveform of the frequency f1 with the threshold for the frequency f1. In addition, the power transmission apparatus 101 or the power reception apparatus 102 compares the signal spectrum specified from the observed attenuated waveform of the frequency f2 with the threshold for the frequency f2. If the signal spectrum for the frequency f1 exceeds the threshold, and the signal spectrum for the frequency f2 exceeds the threshold, the power transmission apparatus 101 or the power reception apparatus 102 determines that “a foreign object exists” or “a possibility that a foreign object exists is high”. Alternatively, if the signal spectrum for the frequency f1 exceeds the threshold, or the signal spectrum for the frequency f2 exceeds the threshold, the power transmission apparatus 101 or the power reception apparatus 102 may determine that “a foreign object exists” or “a possibility that a foreign object exists is high”. That is, if the signal spectrum for at least one of the frequencies f1 and f2 exceeds the threshold, the power transmission apparatus 101 or the power reception apparatus 102 can determine that “a foreign object exists” or “a possibility that a foreign object exists is high”.

This makes it possible to perform foreign object detection more reliably. Note that as described above, the mixed wave of the frequencies f1 and f2 can be observed by both the power transmission apparatus 101 and the power reception apparatus 102. Hence, the foreign object detection method according to this modification can be executed by both the power transmission apparatus 101 and the power reception apparatus 102. Also, in this modification as well, the threshold for the frequency f1 and the threshold for the frequency f2 may be set separately or may be set to identical values.

As described above, at least one of the power transmission apparatus 101 and the power reception apparatus 102 operates as described above to perform foreign object detection based on signal spectra at a plurality of frequencies, thereby more accurately detecting a foreign object.

(Modification 2 of Foreign Object Detection Method by Waveform Attenuation Method Using Plural Frequencies)

In the above-described configuration, the method of detecting a foreign object based on the time waveform of the mixed wave of the frequencies f1 and f2 or the signal spectra of the time waveform at the frequencies f1 and f2 has been described. At this time, in the configuration as described above, if the frequencies f1 and f2 are very close frequencies, correlation of energy consumption by a foreign object is high in these frequencies, and the advantage in performing foreign object detection using a plurality of frequencies is little. In addition, if the difference between the frequency f1 and the frequency f2 is small, a “beat” occurs in the combined wave, and foreign object detection as described above may be difficult. Hence, in this modification, foreign object detection is performed using frequencies different from the frequencies f1 and f2 in place of these frequencies, or using still other frequencies in addition of the frequencies f1 and f2.

For example, the frequency f1 determined by the power transmission antenna 205 and the resonant capacitor 207 of the power transmission apparatus 101 and the frequency f2 determined by the power reception antenna 305 and the resonant capacitor 312 of the power reception apparatus 102 are each defined to be included in a predetermined frequency range. Here, the predetermined frequency ranges are defined such that the frequency f1 and the frequency f2 are apart from each other only by a predetermined frequency width in advance. The values of inductances and capacitances in the power transmission antenna 205 and the resonant capacitor 207 of the power transmission apparatus 101 and the power reception antenna 305 and the resonant capacitor 312 of the power reception apparatus 102 are decided such that these are included in the frequency ranges. This makes it possible to make the frequency f1 and the frequency f2 apart from each other only by a predetermined frequency width and perform more accurate foreign object detection.

Also, the power transmission apparatus 101 or the power reception apparatus 102 includes a plurality of resonant capacitors, as shown in FIGS. 2 and 3, and the resonance frequency in the power transmission apparatus 101 and the resonance frequency in the power reception apparatus 102 can be made apart in advance only by a predetermined frequency width by switching the resonant capacitors. The power transmission apparatus 101 and the power reception apparatus 102 communicate with each other, thereby deciding a first resonance frequency in the power transmission apparatus 101 and a second resonance frequency in the power reception apparatus 102. At this time, the first resonance frequency and the second resonance frequency are set to be apart only by a predetermined frequency width. To implement the first resonance frequency decided between the power transmission apparatus 101 and the power reception apparatus 102, the power transmission apparatus 101 controls, for example, the switch 210 connected to the resonant capacitor 212 and the switch 211 connected to the resonant capacitor 213. The power transmission apparatus 101 executes control of turning on at least one of the switches 209 to 211 such that a circuit configuration capable of obtaining the decided first resonance frequency is formed. Also, to implement the second resonance frequency decided between the power transmission apparatus 101 and the power reception apparatus 102, the power reception apparatus 102 controls, for example, the switch 310 connected to the resonant capacitor 313 and the switch 311 connected to the resonant capacitor 314. The power reception apparatus 102 executes control of turning on at least one of the switches 309 to 311 such that a circuit configuration capable of obtaining the decided second resonance frequency is formed. Thus, each of the power transmission apparatus 101 and the power reception apparatus 102 includes a plurality of resonant capacitors and switches, and appropriately controls these based on information decided between the power transmission apparatus 101 and the power reception apparatus 102, thereby making the resonance frequencies apart. This makes it possible to perform more accurate foreign object detection. Note that the resonant capacitors of the power transmission apparatus 101 and the power reception apparatus 102 and switches connected to these may be provided more than in FIG. 2 or 3. It is therefore possible to more precisely control the resonance frequencies and improve the accuracy of foreign object detection.

Note that in the above-described way, foreign object detection can be performed based on the characteristics (for example, the attenuation rate of the time waveform) of the voltage or current in the resonant circuit at three or more frequencies. At this time, if the characteristic at one of the three or more frequencies exceeds the threshold, it can be determined that a foreign object exists. Also, if the characteristics at two or more (for example, all) of the three or more frequencies exceed the threshold, it may be determined that a foreign object exists.

In addition, control may be performed such that the frequency f1 determined by the power transmission antenna 205 and the resonant capacitor 207 of the power transmission apparatus 101 is set to or near 13.56 MHz that is a frequency band used in NFC (Near Field Communication). In place of or in addition to this, control may be performed such that the frequency f2 determined by the power reception antenna 305 and the resonant capacitor 312 of the power reception apparatus 102 is set to or near 13.56 MHz that is a frequency band used in NFC. For this purpose, the power transmission apparatus 101 or the power reception apparatus 102 performs the control such that the resonance frequency is set to 13.56 MHz by appropriately setting at least one of the inductance and the capacitance or controlling the switch, as described above. Even if an NFC tag or a device that is not the power reception apparatus 102 and uses NFC is placed on the power transmission apparatus 101, it can be detected. Note that NFC is merely an example, and a frequency used in another wireless standard may be used as the resonance frequency in the power transmission apparatus 101 or the power reception apparatus 102. This allows the power transmission apparatus 101 or the power reception apparatus 102 to detect that a device complying with the wireless standard is placed.

In the above-described embodiment, the timing of measuring the waveform attenuation index or the signal spectrum in a state in which no foreign object exists in advance will be described. In the WPC standard, as described above, foreign object detection by the Q-Factor measuring method is performed in the Negotiation Phase. If it is determined, as the result of foreign object detection, that no foreign object exists, the process transits to the Calibration phase and the Power Transfer phase. That is, transition to the phase after the Negotiation Phase means that it is determined by the Q-Factor measuring method that no foreign object exists. For this reason, if the waveform attenuation rate is measured in one of the Negotiation Phase, the Calibration phase, and the Power Transfer phase, the possibility that the waveform attenuation rate in a state in which no foreign object exists can be measured is high. Hence, the timing of measuring the waveform attenuation rate in a state in which no foreign object exists can be set to one of the Negotiation Phase, the Calibration phase, and the Power Transfer phase.

On the other hand, a foreign object may be mixed between the power transmission apparatus 101 and the power reception apparatus 102 during the time after it is confirmed by the Q-Factor measuring method in the Negotiation Phase that no foreign object exists until measurement of the waveform attenuation rate in a state in which no foreign object exists is executed. In this case, it is assumed that the waveform attenuation rate in a state in which no foreign object exists cannot accurately be measured. Hence, it is useful to perform the measurement of the waveform attenuation rate immediately after the absence of a foreign object is confirmed.

To do this, for example, the power reception apparatus 102 detects that the state of the power transmission apparatus 101 or the power reception apparatus 102 has changed, and determines whether updating/addition of a threshold to be used for foreign object detection by the waveform attenuation method is necessary. Upon determining that updating/addition of a threshold is necessary, the power reception apparatus 102 transmits a command of foreign object detection execution by the Power Loss method to the power transmission apparatus 101. According to the reception of the command, the power transmission apparatus 101 executes foreign object detection by the Power Loss method, and determines the presence/absence of a foreign object. Upon determining that no foreign object exists, or the possibility that no foreign object exists is high, the power transmission apparatus 101 notifies the power reception apparatus 102 that no foreign object exists. The power reception apparatus 102 executes an operation of setting a threshold to be used for foreign object detection by the waveform attenuation method or updating/adding a threshold. That is, if notified that no foreign object exists, the power reception apparatus 102 transmits, to the power transmission apparatus 101, a command for requesting execution of measurement for setting a threshold of foreign object detection by the waveform attenuation method. According to the reception of the command, the power transmission apparatus 101 temporarily stops power transmission. In addition, the power transmission apparatus 101 and the power reception apparatus 102 measure the waveform attenuation indices or signal spectra at the frequencies f1 and f2 by controlling the circuits in the above-described way. The power transmission apparatus 101 calculates the threshold of foreign object detection by the waveform attenuation method using the measured waveform attenuation index or signal spectrum and sets this as the threshold.

As described above, upon determining to update/change the threshold of the waveform attenuation method, the power reception apparatus 102 causes the power transmission apparatus 101 to confirm by the Power Loss method that no foreign object exists, immediately before performing an operation for this. If it is confirmed that no foreign object exists, the power reception apparatus 102 executes the operation for updating/changing the threshold of the waveform attenuation method. Thus, in measurement for setting the threshold of foreign object detection by the waveform attenuation method, it is possible to sufficiently raise the probability that a state in which no foreign object exists can be obtained and more accurately set the foreign object detection threshold.

In the above-described example, the method of confirming by the Power Loss method that no foreign object exists, immediately before performing the operation for updating/changing the threshold of the waveform attenuation method, has been described. However, the threshold to be used to determine the presence/absence of a foreign object exists in the Power Loss method as well. As for the threshold of the Power Loss method as well, it may be necessary to update/add the threshold if the state of the power transmission apparatus 101 or the power reception apparatus 102 has changed, as in the waveform attenuation method. The updating/addition of the threshold can be done in the Power Transfer phase. That is, like the above-described method, upon determining to set or update/change the threshold of the Power Loss method, the power reception apparatus 102 executes processing for confirming by the waveform attenuation method that no foreign object exists, immediately before performing an operation for this. If it is confirmed, by the waveform attenuation method, that no foreign object exists, the power reception apparatus 102 can execute the operation for updating/changing the threshold of the Power Loss method. Upon determining that, for example, updating/addition of a threshold to be used for foreign object detection by the Power Loss method is necessary, the power reception apparatus 102 transmits a command of foreign object detection execution by the waveform attenuation method to the power transmission apparatus 101. According to the reception of the command, the power transmission apparatus 101 executes foreign object detection by the waveform attenuation method, and determines the presence/absence of a foreign object. Upon determining that no foreign object exists, or the possibility that no foreign object exists is high, the power transmission apparatus 101 notifies the power reception apparatus 102 that no foreign object exists. If notified that no foreign object exists, the power reception apparatus 102 executes an operation of updating/adding a threshold to be used for foreign object detection by the Power Loss method. That is, to update/add the threshold to be used for foreign object detection, the power reception apparatus 102 transmits, to the power transmission apparatus 101, a command for requesting execution of measurement for setting the threshold of foreign object detection by the Power Loss method. The power reception apparatus 102 controls the loads such that a configuration corresponding to the transmitted power of the threshold (point) to be updated/added is formed. Upon receiving the command, the power transmission apparatus 101 calculates and sets the threshold of foreign object detection by the Power Loss method. It is therefore possible to sufficiently raise the probability that a state in which no foreign object exists can be obtained when executing for setting the threshold of foreign object detection by the Power Loss method and more accurately set the foreign object detection threshold. In the above-described embodiment, power transmission is stopped for foreign object detection. However, instead of completely stopping power transmission, power may be suppressed up to power close to, for example, zero.

According to the present disclosure, it is possible to accurately perform detection of an object different from a power reception apparatus.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

1. A power transmission apparatus comprising:
a power transmission unit configured to wirelessly transmit power to a power reception apparatus via an antenna;
a control unit configured to control to limit power transmission by the power transmission unit during a period; and
a detection unit configured to detect an object different from the power reception apparatus based on a temporal change of a voltage or a current of the antenna corresponding to a first frequency during the period when the power transmission is limited and based on a temporal change of a voltage or a current of the antenna corresponding to a second frequency different from the first frequency, during the period when the power transmission is limited.

2. The power transmission apparatus according to claim 1, wherein the second frequency is a frequency corresponding to a resonance frequency of a resonant circuit formed in the power reception apparatus.

3. The power transmission apparatus according to claim 1, wherein
the control unit controls to stop or suppress power transmission by the power transmission unit during the period, and
the detection unit detects the object based on the temporal change of attenuation of the voltage or the current of the antenna during the period when power transmission by the power transmission unit is stopped or suppressed.

4. The power transmission apparatus according to claim 3, wherein the detection unit detects the object in a case where an attenuation rate that is a ratio of a magnitude of the attenuation to time is larger than a threshold.

5. The power transmission apparatus according to claim 4, wherein the detection unit detects the object in a case where the attenuation rate corresponding to at least one of the first frequency and the second frequency is larger than the threshold.

6. The power transmission apparatus according to claim 1, wherein
the control unit controls to stop or suppress power transmission by the power transmission unit during the period, and
the detection unit detects the object based on a frequency spectrum corresponding to the temporal change of the voltage or the current of the antenna during the period in which power transmission by the power transmission unit is stopped or suppressed.

7. The power transmission apparatus according to claim 6, wherein the detection unit detects the object in a case where a magnitude of the frequency spectrum is smaller than a threshold.

8. The power transmission apparatus according to claim 7, wherein the detection unit detects the object in a case where the magnitude of the frequency spectrum corresponding to at least one of the first frequency and the second frequency is smaller than the threshold.

9. The power transmission apparatus according to claim 1, wherein
the power transmission apparatus includes a resonant circuit including a resonant capacitor connected to the antenna, and
the control unit performs control for changing a resonance frequency of the resonant circuit.

10. The power transmission apparatus according to claim 1, wherein at least one of the first frequency and the second frequency is a frequency used in a wireless standard different from a standard associated with wireless power transmission.

11. A power reception apparatus comprising:
a power reception unit configured to wirelessly receive power from a power transmission apparatus via an antenna; and
a detection unit configured to detect an object different from the power transmission apparatus based on a temporal change of a voltage or a current of the antenna corresponding to a first frequency during a period when power transmission from the power transmission apparatus is limited and based on a temporal change of a voltage or a current of the antenna corresponding to a second frequency different from the first frequency, during the period when the power transmission from the power transmission apparatus is limited.

12. The power reception apparatus according to claim 11, wherein the first frequency is a frequency corresponding to a resonance frequency of a resonant circuit formed in the power transmission apparatus.

13. The power reception apparatus according to claim 11, wherein
the power transmission apparatus stops or suppresses power transmission during the period, and
the detection unit detects the object based on the temporal change of attenuation of the voltage or the current of the antenna during the period in which power transmission by the power transmission apparatus is stopped or suppressed.

14. The power reception apparatus according to claim 13, wherein the detection unit detects the object in a case where an attenuation rate that is a ratio of a magnitude of the attenuation to time is larger than a threshold.

15. The power reception apparatus according to claim 11, wherein
the power transmission apparatus stops or suppresses power transmission during the period, and
the detection unit detects the object based on a frequency spectrum corresponding to the temporal change of the voltage or the current of the antenna during the period when power transmission by the power transmission apparatus is stopped or suppressed.

16. The power reception apparatus according to claim 11, wherein
the power reception apparatus further comprises:
a resonant circuit including a resonant capacitor connected to the antenna; and
a control unit configured to perform control for changing a resonance frequency of the resonant circuit.

17. A control method executed by a power transmission apparatus configured to wirelessly transmit power to a power reception apparatus via an antenna, comprising:
controlling to limit power transmission during a period; and
detecting an object different from the power reception apparatus based on a temporal change of a voltage or a current of the antenna corresponding to a first frequency during the period when the power transmission is limited and based on a temporal change of a voltage or a current of the antenna corresponding to a second frequency different from the first frequency, during the period when the power transmission is limited.

18. A control method executed by a power reception apparatus configured to wirelessly receive power from a power transmission apparatus via an antenna, comprising
detecting an object different from the power transmission apparatus based on a temporal change of a voltage or a current of the antenna corresponding to a first frequency during a period when power transmission from the power transmission apparatus is limited, and based on a temporal change of a voltage or a current of the antenna corresponding to a second frequency different from the first frequency, during the period when the power transmission from the power transmission apparatus is limited.

19. A non-transitory computer-readable storage medium that stores a program for causing a computer included in a power transmission apparatus that wirelessly transmits power to a power reception apparatus via an antenna to:
control to limit power transmission during a period; and
detect an object different from the power reception apparatus based on a temporal change of a voltage or a current of the antenna corresponding to a first frequency during the period when the power transmission is limited and based on a temporal change of a voltage or a current of the antenna corresponding to a second frequency different from the first frequency, during the period when the power transmission is limited.

20. A non-transitory computer-readable storage medium that stores a program for causing a computer included in a power reception apparatus that wirelessly receives power from a power transmission apparatus via an antenna to
detect an object different from the power transmission apparatus based on a temporal change of a voltage or a current of the antenna corresponding to a first frequency during a period when power transmission from the power transmission apparatus is limited, and based on a temporal change of a voltage or a current of the antenna corresponding to a second frequency different from the first frequency, during the period when the power transmission from the power transmission apparatus is limited.
